(19) United States
(12) Patent Application Publication
(10) Pub. No.: US 2003/0136897 A1
(43) Pub. Date: Jul. 24, 2003

(54) Input interface and method

(76) Inventor: Boris Rabkin, Toronto (CA)

Correspondence Address: PENNIE AND EDMONDS, 1155 AVENUE OF THE AMERICAS, NEW YORK, NY, 100362711

(21) Appl. No.: 10/050,549

(22) Filed: Jan. 18, 2002

(51) Int. Cl. H01J 40/14; G06M 7/00

(52) U.S. Cl. 250/221

(57) ABSTRACT

An apparatus and method for sensor-based interface with feedback are provided for user input to programmable electrical systems, the sensor having a long life and high reliability and being activated by a user action, where the sensor is, for example, a photoelectric sensor, magnetic sensor, Hall effect based sensor, sensor based on capacitance change, proximity sensor, and a resistance sensor. Inputs are made in a predetermined sequence of preset ‘time windows’ by having a user, while in close proximity to the sensor, provide power to the electrical system to initiate a programming sequence and then activate the sensor one or more times in order to set the preprogrammed sequence of variable control values. Feedback of each activation as it is sensed by the sensor is provided immediately to the user, for example by a light emitting diode (LED) and default values result from lack of input.

### BACKGROUND OF THE INVENTION

1. Field of the Invention

The present invention relates to user input to programmable electronic devices. More particularly, the present invention is a sensor-based interface which employs changes in sensed parameters as inputs to programmable electronic devices.

2. Discussion of Related Art

Environmental parameters are commonly monitored by sensor apparatus to provide feedback concerning changes in these parameters that exceed predetermined tolerances. Sequential changes in such parameters can be used as inputs to programs that direct some action in response to such a sequence of changes.

Programmable electronic devices are commonplace that have default settings for programmable options, including values and function choices, each of which can be revised to provide customized settings in accordance with user preferences. Typically, input to such programmable devices is provided by manually manipulating different input devices for the various programmable options and groups of options. Feedback is provided by displaying the provided input in any one of several formats such as a display screen or a function-specific lighted indicator. The trend is toward sharing displays for multiple user inputs, thereby allowing a user to review multiple such settings in a common format.

Mechanically manipulated switches are the input mechanism of choice and can include sealed touch panels which act as manual switches by completing an electric circuit when touched by a user at indicated positions, as well as rocker switches, rotary knobs, and slidable indicators or the like. However, many such mechanically manipulated switches can be unreliable both in the long run and in hostile or hazardous environments and cannot be made more reliable for a low cost per control. Further, the complexity of the parameter-setting protocol contributes to the cost, overall, of user input mechanisms for programmable electronic devices. Electromechanical input devices are not cost effective for environmentally hostile or hazardous applications.

### SUMMARY OF THE INVENTION

Thus there is a need for an alternative to conventional user input mechanisms for programmable electronic devices that is both low cost and reliable over the long run and in both hostile and hazardous usage environments. The present invention provides an apparatus and method that employs a sensor to achieve a low cost user input interface that is both cost effective and reliable in all usage situations. Further, the input interface can be used to monitor the environment when it is not being used as a user input interface.

Thus, the present invention provides an apparatus and method for a single sensor to fulfill two functions: as a user interface for parameter input to programmable electronic device, and as an environmental sensor. This duality of use is achieved without use of any additional input channels and without accidental modification of previously programmed parameters.

In a preferred embodiment, sealed electromechanical buttons were replaced with a photosensor interface according to the present invention as an input mechanism for a garden light controller and a single LED was provided as a feedback mechanism. The resulting reduction in complexity of the printed circuit board increased reliability while decreasing the manufacturing cost by 40%. The construction of sealed buttons for use in the outdoor environment is costly due to the wide range of temperatures in which the button's moving parts must perform reliably. Further, the single LED output of this embodiment significantly decreased the number of microcontroller output pins required to indicate programmed parameters. For example, to employ widely used 7-segment LED indicators to indicate parameters in a range of 0 to 9, it is necessary to use 7 output pins compared with one LED indicator in this embodiment of the present invention. As a result, the number of required microcontroller outputs dropped, allowing the use of smaller and lower cost microcontrollers. However, the use of a single LED as an input feedback and display mechanism is only one example of a low-cost approach according to the present invention, and it would be obvious to one skilled in the art that this single LED can be eliminated completely or replaced by a variety of display types in accordance with the requirements of the application of the present invention as a user input interface to a programmable electronic device. For example, when the device output state is indicative of the acceptance of user input, there is no need for a separate input feedback and display mechanism.

### BRIEF DESCRIPTION OF THE DRAWINGS

FIG. 1 illustrates an embodiment employing a photoelectric sensor with a single LED for feedback.

FIG. 2 illustrates (a) the state of the photoelectric sensor of FIG. 1 during a typical parameter input sequence for both user input and default parameter setting, initiated by powering on the device, and (b) the corresponding output of the single LED of a device of the embodiment of FIG. 1.

FIG. 3 illustrates a flow chart of one embodiment of a method for programmed control of an electronic device employing the present invention as a user input interface.

FIG. 4 illustrates an embodiment of the present invention which employs a photoelectric sensor as a user input interface to a programmable low voltage load, such as a garden light controller.

FIG. 5 illustrates an embodiment of the present invention which employs a reed contacts based sensor as a user input interface to a programmable low voltage load, such as a garden light controller, from a location without exposure to ambient light.

FIG. 6 illustrates an implementation of the present invention that employs a Hall-effect sensor controlled by a magnet as a user input interface to a programmable device in an application requiring a sealed device housing without moving parts.

FIG. 7 illustrates an embodiment of the present invention that employs a proximity sensor as a user input interface to a programmable device in an application requiring a sealed device housing without moving parts.

FIG. 8 illustrates an embodiment of the present invention that employs a resistance sensor that is sensitive to the level of a substance contained in a tank as an input interface to a programmable device in an embodiment requiring a measure of the input level deviation from a known position.

### DETAILED DESCRIPTION OF PREFERRED EMBODIMENTS

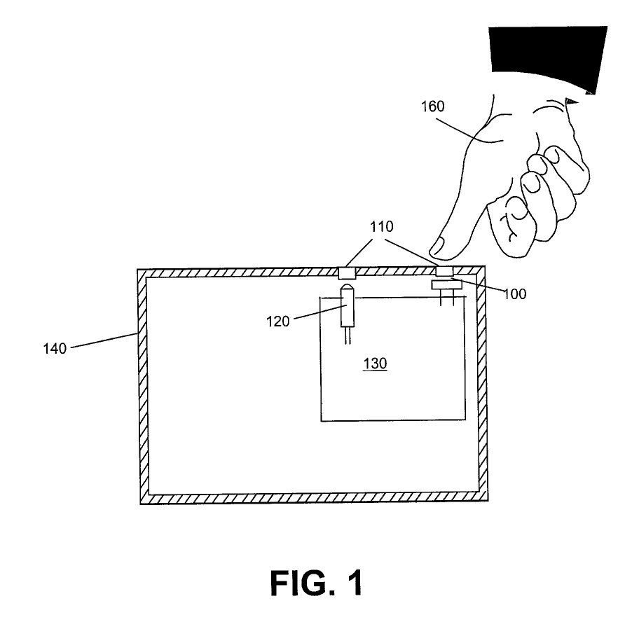

Referring now to FIG. 1, a preferred embodiment is shown of the present invention employing a lens 10 as an input port transmitting visible light from a source (not shown) to a photoelectric sensor 10 in a user input interface controlled by a printed circuit board 13. Also illustrated in FIG. 1 is a single LED 12 which acts to provide a visual feedback or indicator through an output port or light transparent lens 11. In this embodiment, a photoelectric sensor 10 is enclosed in an optically opaque housing 14. The photoelectric sensor 10 is exposed to light from a source (not shown) through a lens 11 that is transparent to visible light. In this embodiment, a user's finger 16 or any optically opaque object can be employed to interrupt light from the source from reaching the sensor 10. Each such interruption is a discrete input in this embodiment.

In this preferred embodiment of the device of the present invention, a user enters information by providing a discrete input transmitted through an input port to a sensor during a specially allocated ‘time window’ for each such piece of information. In this manner, a predetermined sequence of parameter inputs can be made by a user by allocating a sequence of finite duration ‘time windows’ to each such input. If no such input is received during a given ‘time window’ then the corresponding parameter is set to a predetermined standard/default setting. As illustrated in FIG. 1, a user receives feedback confirmation of every such input by a change in the state of a feedback indicator, such as the LED 12.

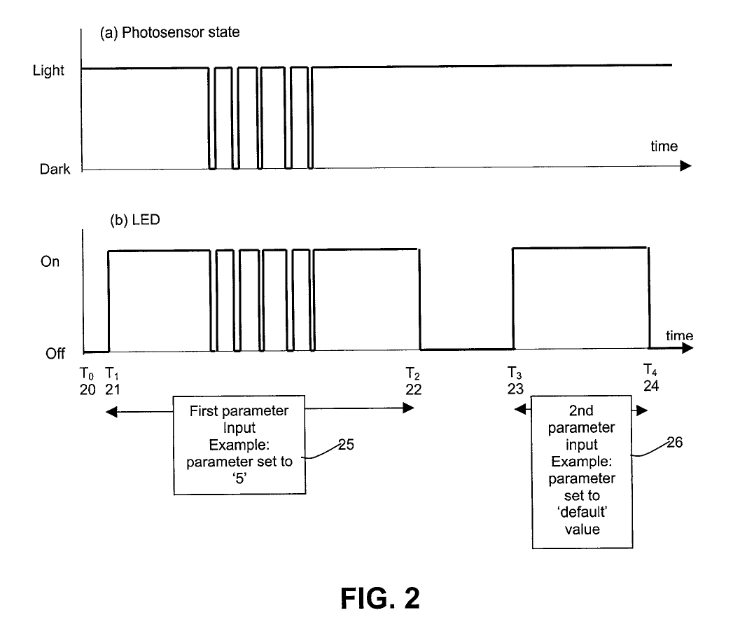

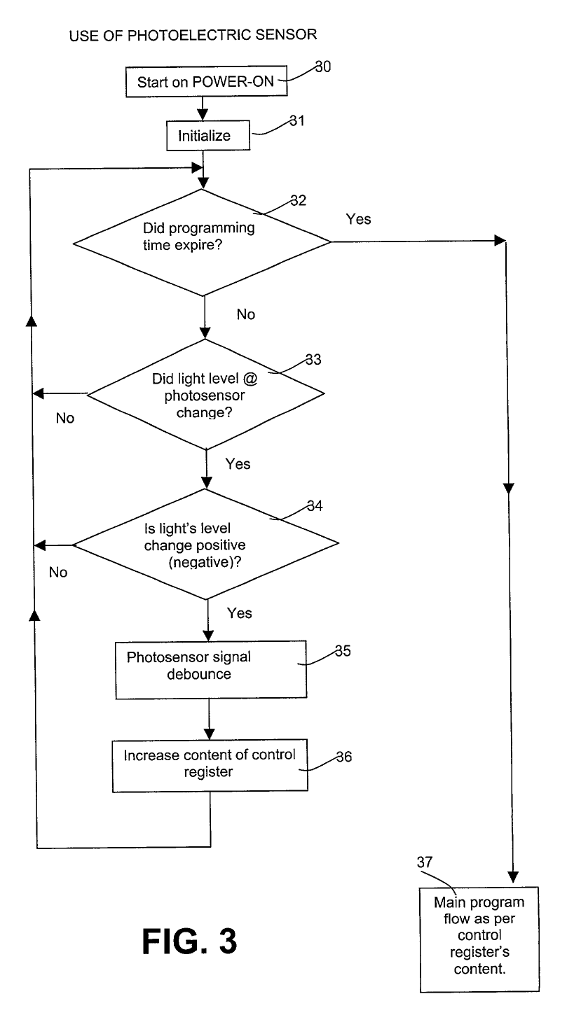

In order to begin the sequence of inputs, in a preferred embodiment, the programmable electronic device is supplied with a power source, e.g., by being plugged into an AC outlet 30. In a preferred embodiment, as illustrated in FIGS. 2 and 3, the programmable device is energized by a power source at time T₀ 20 30, and initialization 31 of the programmable device is completed at time T₁ 21. Then, the programmable device switches into ‘programming mode’ for a preset period of ‘time window’ T₁-T₂ 32 in order to receive input corresponding to a first parameter 25. The start of ‘programming mode’ for the first parameter 25 is indicated by turning the LED 12 ‘ON’ (not shown in FIG. 3) at time T₁ 21 while the end of programming mode for the first parameter 25 is indicated by turning the LED 12 OFF (not shown in FIG. 3) at time T₂ 22.

During the period of time between T₁ and T₂, each intentional interruption of the light 34 from the source reaching the photoelectric sensor 10 is regarded as an input which results in changing the contents of a control register 36, as shown in FIG. 3. In order for an interruption to qualify as an input not only must the light level reaching the sensor 10 have changed 33 but it must change in a given direction 34 and be debounced 35. Only then is the content of a control register incremented 36 to indicate an input has been received. When the programming period of the ‘time window’ expires 32 the appropriate parameter will be set to the value of the control register or a default value, the latter if the control register contents are zero indicating no input received via the photoelectric sensor. For example, as shown in FIG. 2, five interruptions of the light from the source result in setting a first parameter to a value of five (5). Different final values of the control register can result in different actions when the program 37 controlling the device is run. If more than one parameter is to be input, additional parameters can be entered in an analogous manner by having a second, third, etc., window in sequence, e.g., T₃ 23 followed by T₄ 24. In FIG. 2 the second window in sequence is not used for input and the corresponding second parameter is set to a ‘default’ value 26.

If another type of input port and corresponding sensor is employed, the conditions that must be satisfied for reception of a valid input will vary according to the type. However, the logic flow concept illustrated in FIG. 3 will be the same and the physical sensor and LED states will correspond to that of a photoelectric sensor, but will be particularized to the type of being used. For example, instead of light and dark, for a proximity type input port (which transmits infrared radiation from a nearby source), the presence or absence of a heat radiation increase detected by the sensor can indicate a discrete input. As one skilled in the art will realize, other types of sensors which can be used include, but are not limited to a magnetic sensor, Hall effect-based sensor, sensor based on capacitance change, proximity sensor and resistance sensor. The corresponding input port for each of these example sensors is selected for its ability to transmit a discrete input signal of the type that can be sensed.

In addition to specifying the value of a settable parameter, the state of a sensor at the beginning and end of a ‘time window’ can be used to initiate special functions. For example, programming that employs a photoelectric sensor to detect input is expecting a lighted environment. Activation of the programmable device by supplying a power supply in the dark or restoration of power following a power failure can result in the programmable device entering a default mode of operation.

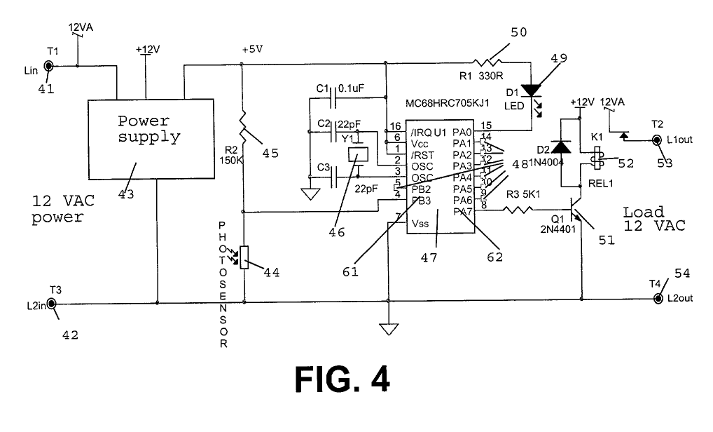

FIG. 4 illustrates an example of a preferred embodiment of the present invention employing a photoelectric sensor for providing input to a low voltage load, such as a programmable garden light controller. The example of FIG. 4 comprises:

terminals 41 and 42 to provide for incoming power;

power supply 43;

photoelectric sensor 44 of the light dependent resistor type;

microcontroller 47 with crystal oscillator 46;

inputs/outputs 48 for the main device functions;

light emitting diode (LED) 49 with current limiting resistor 50;

load control relay 52 driven by transistor 51; and

terminals 53 and 54 for connecting the load.

In this example of a preferred embodiment, incoming 12 VAC through terminals 41 and 42 is applied to the power supply 43 and to the load through normally open contact relay 52. Power supply 43 provides 5 VDC and 12 VDC necessary for the programmable device to function. Light dependent voltage divider comprises photoelectric sensors 44 and resistor 45 and the resulting voltage is applied to the input PB3 61 of microcontroller 47. In this example of a preferred embodiment, port PB3 61 is configured as an input with pull down resistor disabled. Microcontroller 47 recognizes the voltage level on input PB3 61 as either ‘HIGH’ or ‘LOW’ and analyzes inputs and controls outputs according to the control program loaded into the device.

The device of the example preferred embodiment of FIG. 4 provides visual feedback via LED 49 and is the simplest and least expensive means for indicating feedback by using a sequence of flashes and pauses of variable duration. Output PA7 62 controls relay 52 using transistor 51 and the relay's contacts control power to the load connected to terminals 53 and 54.

When power is first applied to the device, microcontroller 47 performs the initialization process, setting up the proper internal configuration for device operation. After completion of the initialization process, microcontroller 47 switches to programming mode during which every interruption of light from the source (not shown) to the photosensor 44 is regarded as a discrete input. The duration of programming mode is preset by the control program. After expiration of this preset programming duration, microcontroller 41 switches to nominal mode, during which mode all changes to light reaching photosensor 44 are regarded as a parameter being monitored by the device. In the preferred embodiment employing a photosensor as an input device for a garden light controller, the control program turns power ON to the load at dark and turns power OFF to the load at dawn or after some preset time after dark has expired.

The cost of the printed circuit board assembly in this example embodiment was reduced by almost 40% and the reliability was increased. In this embodiment, space requirements also were decreased over a prior implementation of sealed electromechanical buttons.

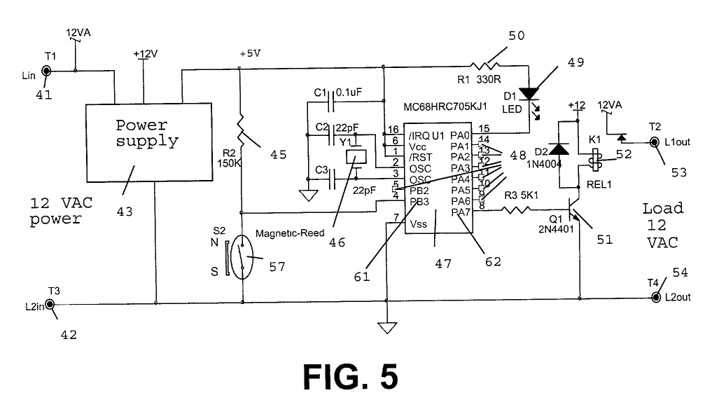

FIG. 5 illustrates a preferred embodiment in which the sensor is a reed contacts based sensor 47, controlled by a magnet. This embodiment can comprise a sealed device housing for hostile usage environments.

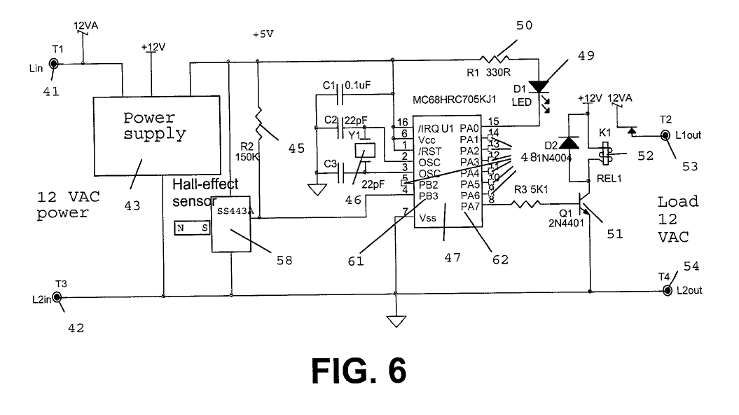

FIG. 6 illustrates a preferred embodiment using a Hall-effect sensor 58, also controlled by a magnet. This embodiment improves on the embodiment of FIG. 5 derived from the reliability of solid state technology used to produce the sensor. Further, this embodiment allows the device to be incased in a sealed device housing without moving parts, further improving on the device of the embodiments of FIG. 5.

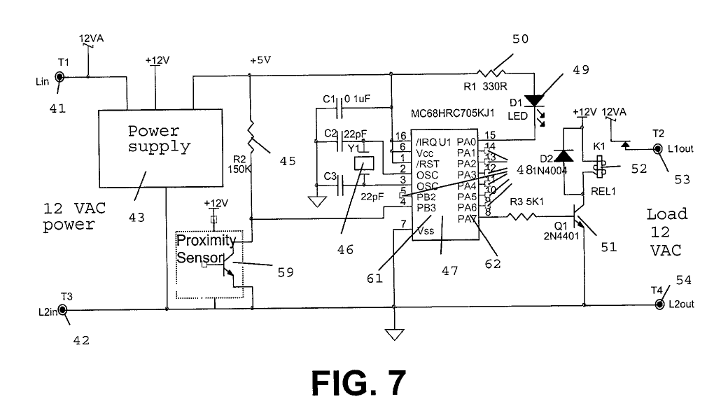

FIG. 7 illustrates an embodiment employing a proximity sensor 59, sensitive to the position of specific input media. This embodiment provides the advantage of a greater variety of input media than that of the embodiment of FIG. 6 while still allowing the device to be encased in a sealed device housing without moving parts.

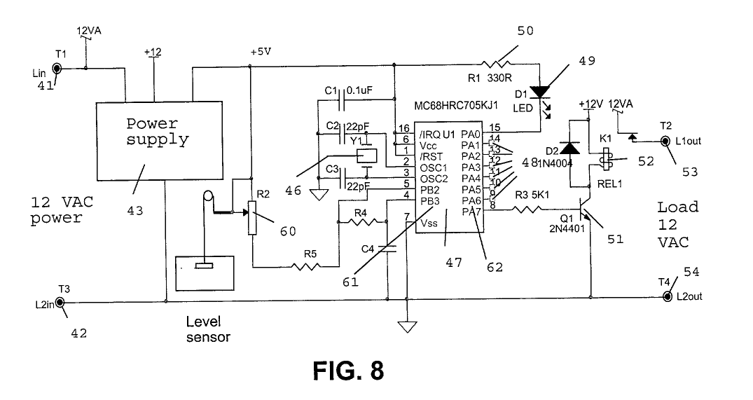

FIG. 8 illustrates an embodiment employing a resistance sensor 60, sensitive to the level of a substance in a tank. The advantage of this embodiment is that level deviations during the programming mode can be used to specify permitted level deviations during the nominal mode.

While certain embodiments have been presented in which this invention provides an input interface to a programmable electronic device, these are illustrative only and are not limiting in any sense. That is, this invention is not limited to use with programmable electronic devices. As one skilled in the art will realize, other applications of the invention are possible. By way of example only, the device of the present invention can be used for monitoring ambient levels of particular parameters with an indicator for displaying changes in values of monitored phenomena when changes exceed predetermined threshold values, e.g., an alarm sounds when a temperature exceeds a prespecified value.

I claim:

1. An input interface for a programmable electronic device of a type having a control panel and an operating mode, said input interface comprising:
at least one input port means incorporated into said control panel for transmission therethrough of at least one type of discrete input;
a sensor positioned with respect to said at least one input port means for sensing transmission therethrough of said at least one type of discrete input and creating a signal corresponding to each said at least one type of discrete input;
a mode setting means for setting said operating mode to a mode selected from the group consisting of default mode, programming mode, and nominal mode;
a control means for processing each said signal created by said sensor in accordance with said operating mode, such that when said operating mode is programming mode said control means performs at least one of setting at least one programmable parameter or initiating at least one predetermined programmable action for said programmable electronic device.

2. The input interface of claim 1, wherein:
said input port means is a lens that is transparent to a visible light from a source; and
said sensor is a photoelectric sensor;
wherein, each interruption of the light from the source from reaching said input port is said at least one type of discrete input.

3. The input interface of claim 1, wherein said control means is a microcontroller having a program that creates a sequence of at least one time interval of predetermined length during which each said discrete input is counted in a control register, each said time interval having a corresponding settable parameter that is set by the microcontroller to the count in the control register at the end of said time interval and a corresponding default setting if no discrete input is received during said time interval.

4. The input interface of claim 3 wherein said mode setting means sets said operating mode to—
programming mode for a predetermined period of time when an electrical power is first supplied to said programmable electronic device and after an initialization time period a first predetermined sensor input is supplied,
a default mode when an electrical power is first supplied to said programmable electronic device and after an initialization time period when any input is supplied other than said at least a first predetermined sensor input, and
a nominal mode when said electronic device is set to said programming mode and said predetermined period of time expires for said programming mode.

5. The input interface of claim 1, further comprising a feedback mechanism having a state indicative of said at least one discrete input.

6. The input interface of claim 5, wherein said control means further comprises activating said feedback mechanism to indicate at least one of the control register value at the end of each said at least one time interval or the acceptance of each of said at least one type of discrete input.

7. The input interface of claim 1, wherein:
said sensor is selected from the group comprising magnetic sensor, Hall effect sensor, sensor based on capacitance change, proximity sensor, and resistance sensor;
said input port means is capable of creating and transmitting or transmitting at least one type of discrete input which can be sensed by said sensor.

8. The input interface of claim 1, wherein at least one of said at least one input port or said programmable electronic device is protected from environmental hazards.

9. A method for an input interface to a programmable electronic device, comprising the steps of:
providing at least one input port to said electronic device for transmission therethrough of at least one type of discrete input;
converting said transmitted at least one type of discrete input by a sensor to a signal;
processing said signal to accomplish at least one of specification of a value of at least one programmable parameter, or execution of at least one programmable action.

10. The method of claim 9, further comprising the step of providing a feedback mechanism to indicate at least one of a value input for at least one programmable parameter, acceptance of said at least one discrete input, or execution of said at least one programmable action.

11. The method of claim 9, wherein said sensor is at least one selected from the group comprising photoelectrical sensor, magnetic sensor, Hall effect sensor, sensor based on capacitance change, proximity sensor, and resistance sensor.

12. The method of claim 9, wherein at least one of said at least one input port or said programmable electronic device is protected from environmental hazards.
